(19) United States
(12) Patent Application Publication
(10) Pub. No.: US 2011/0276279 A1
(43) Pub. Date: Nov. 10, 2011

(54) FAULT DIAGNOSTICS ARRANGEMENT FOR ELECTRIC DRIVE SYSTEM, AND ELECTRIC DRIVE SYSTEM

(75) Inventors: Osmo Pasuri, Ojakkala (FI); Jorma Keronen, Espoo (FI); Reijo Virtanen, Vantaa (FI)

(73) Assignee: ABB Oy, Helsinki (FI)

(21) Appl. No.: 13/102,564

(22) Filed: May 6, 2011

(30) Foreign Application Priority Data
May 7, 2010 (FI) 20105495

(51) Int. Cl. G06F 19/00

(52) U.S. Cl. 702/35

(57) ABSTRACT

An exemplary electric drive system has a plural number of electric drive subsystems. Each subsystem having a fault diagnostics arrangement, where the arrangement includes a respective control board for each subsystem. Event data of each subsystem is recorded on the respective control board, and one of the respective control boards of the electric drive system is a main control board of the electric drive system. Event data of a subsystem is transferred from the respective control board to the main control board through a data transfer medium.

### RELATED APPLICATION

This application claims priority under 35 U.S.C. §119 to Finnish Patent Application No. 20105495 filed in Finland on May 7, 2010, the entire content of which is hereby incorporated by reference in its entirety.

### FIELD

The disclosure relates to electric drives, such as industrial electric drives for turbines of wind power or electric drives for solar power, and particularly to fault diagnostics for electric drive systems.

### BACKGROUND INFORMATION

Industrial electric drives can be used for various applications, such as transport vehicle engines, different process and manufacturing technological devices and in energy industry. Electric drives can also be used in transport devices, such as an underground railway service or a shipping service, for example. In process and manufacturing technologies, electric drives can be used in conveyors, mixers, or paper machines, for example. In the energy industry, electric drives can be used in turbines of wind power systems or in solar power systems industry, for example.

The most common types of electric drives can be direct current drives and alternating current drives. In direct current applications the current flowing through the field winding of the motor stator can generate a magnetic field that is oriented perpendicular to the field generated by the armature coil. This can provide a direct current motor with a torque that is easy to adjust in direct current use by changing the armature current and by maintaining a constant exciting current. In direct current use, the armature current also can allow the rate of the direct current motor to be adjusted directly.

Electric drives based on alternating current can be further divided into frequency-controlled alternating current drives, flux-vector-controlled alternating current drives and alternating current drives using direct torque control (DTC). Of these, the alternating current drives based on flux vector control and DTC alternating current drives allow the torque of a three-phase motor to be adjusted, whereas in a frequency-controlled alternating current drive the load on the three-phase motor determines the torque.

FIG. 1 illustrates the structure of an electric drive in accordance with the prior art. The electric drive comprises a power supply 1, a frequency converter 2, and a load 3. The load 3 can be a motor 3, for example. The frequency converter 2 can include (e.g., consist of) a rectifier unit 4, a direct voltage intermediate circuit 5 and an inverter unit 6. The rectifier unit 4 of the frequency converter 2 converts alternating voltage coming from power supply 1 to direct voltage. The frequency converter 2 can be rectified by a 6-pulse diode bridge, for example. The direct voltage obtained from the rectifier unit 4 of the frequency converter 2 is stored to a direct voltage intermediate circuit 5 serving as an energy storage. The direct voltage intermediate circuit 5 of the frequency converter 2 can be implemented by means of storage capacitors. From the direct current of the direct voltage intermediate circuit 5, the inverter unit 6 of the frequency converter 2 produces alternating current having a frequency specified by the motor 3 representing the load. Generally, having the inverter unit 6 of the frequency converter 2 can be implemented by means of IGBTs (IGBT, Insulated-gate Bipolar Transistor), for example.

FIG. 2 illustrates the structure of an alternative electric drive in accordance with the prior art. The alternative electric drive comprises a power supply 7 and a load including (e.g., consisting of) a number of motors 8, 9, 10. In addition, the alternative electric drive comprises a rectifier unit 11, a direct voltage intermediate circuit 12 and a number of separate inverter units 13, 14, 15. The rectifier unit 11 of the electric drive converts alternating current coming from the power supply 7 to direct voltage, which is stored into the direct voltage intermediate circuit 12 serving as an energy storage. From the direct current of the direct voltage intermediate circuit 12 the separate inverter units 13, 14, 15 of the electric drive produce alternating current of a desired frequency for their respective motors 13, 14, 15 representing the load.

Electric drives are often used under demanding circumstances and often also for critical applications. In fact, one of the main specifications imposed on an electric drive is its operational reliability. When an electric drive is damaged in an uncontrollable manner, a worst case scenario can include the motor representing the load and the machine itself also becoming damaged and causing great cumulative damage.

In some prior art electric drives, each device or subsystem can have a separate control board to control the operation of the device or subsystem in a fault situation. In the event of a critical fault, the control board can shut the subsystem down and, when less critical faults are concerned, the control board can perform a corrective action by changing the control. All faults appearing in the device or the subsystem can be recorded in a fault logger of the control board.

FIG. 3 illustrates an electric drive having a fault diagnostics arrangement in accordance with the prior art. The prior art electric drive comprises three frequency converter units 17, 18, 19 and a generator 20. When the generator 20 is running, the frequency converter units 17, 18, 19 convert the electricity produced by the generator 20 to correspond to the frequency of the mains and supply the electricity thus generated to a network 16. Each of the frequency converter units 17, 18, 19 of the prior art electric drive comprises a rectifier unit, a direct voltage intermediate circuit and an inverter unit. Each inverter unit comprises a separate control board 21, 22, 23 and an inverter-unit-specific fault logger residing on the control board 21, 22, 23. The fault logger on the control board 21, 22, 23 documents all faults, warning and other events in accordance with the prior art. Event history stored in the fault logger of the control board 21, 22, 23 of the inverter unit in the frequency converter can be read by and also copied into a computer afterwards.

In the frequency converter units 17, 18, 19 of the prior art electric drive each rectifier unit can comprise a separate control board 24, 25, 26 and a rectifier-unit-specific fault logger residing on the control board 24, 25, 26. Also the fault logger on the control board 24, 25, 26 of the rectifier unit documents all faults, warnings and other events in accordance with the prior art. Similarly, event history stored in the fault logger of the control board 24, 25, 26 of the rectifier unit in the frequency converter can be read by and also copied into a computer afterwards. FIG. 3 shows a computer, which in a fault diagnostics situation, for example, can be connected over separate connections to read the fault logger data of the control boards 21, 22, 23 of the inverter unit and also those of the control boards 24, 25, 26 of the rectifier unit.

The fault diagnostics arrangement of a prior art electric drive can become complicated in that addition to inverter units and rectifier units, the electric drive can comprise a number of other subsystems, such as a brake chopper subsystem and/or a liquid cooling plant subsystem. In addition to these subsystems, the electric drive can comprise diverse other subsystems, some of which are not involved in the motor control. Each subsystem thus can also have a separate subsystem-specific control board and a separate fault logger data file of the control board.

The prior art fault diagnostics arrangement for an electric drive can have major shortcomings. The numerous connections used in a fault examination situation can be laborious and complicated. Moreover, the prior art fault diagnostics arrangement does not give a reliable picture of the fault situation on the main system level of the electric drive. It has been noticed that in a fault examination situation the fault logger data of the subsystem-specific control boards 21 to 26 are difficult to analyse and place in a chronological order. In a prior art electric drive system, it can be difficult to conclude how the fault has emerged and advanced and also which part of the electric drive has been damaged.

Consequently, there is clearly a need and demand in industrial electric drive applications for novel fault diagnostics solutions that allow a sufficiently reliable picture of a fault situation to be conveyed on the main system level of the electric drive and facilitate the analysis of fault logger data in a fault examination situation, for example.

### SUMMARY

An exemplary fault diagnostics arrangement for an electric drive system is disclosed. The fault diagnostics arrangement has a plurality of electric subsystems and comprises control boards having event data of the subsystems recorded thereon. One of the control boards of the electric drive system is a main control board to which the event data of each subsystem is transferred from a respective control board by a data transfer medium.

An exemplary electric drive system comprises a plural number of electric drive subsystems having a fault diagnostics arrangement. The arrangement comprises a respective control board for each subsystem, wherein event data of each subsystem is recorded on the respective control board. One of the respective control boards of the electric drive system is a main control board of the electric drive system to which the event data of a subsystem is transferred from the respective control board by a data transfer medium.

### BRIEF DESCRIPTION OF THE DRAWINGS

Prior art is disclosed in greater detail in the following, with reference to the accompanying figures in which

FIG. 1 illustrates a structure of an electric drive in accordance with the prior art;

FIG. 2 illustrates a structure of an alternative electric drive in accordance with the prior art;

FIG. 3 illustrates an electric drive having a fault diagnostics arrangement in accordance with the prior art;

FIG. 4 illustrates an electric drive having a fault diagnostics arrangement an exemplary embodiment of the present disclosure;

FIG. 5 illustrates an electric drive having a fault diagnostics arrangement in accordance with an alternative exemplary embodiment of the present disclosure;

FIG. 6 illustrates an electric drive having a fault diagnostics arrangement of a second alternative exemplary embodiment of the present disclosure; and

FIG. 7 illustrates the recording of faults in an electric drive having a fault diagnostics arrangement of an exemplary embodiment of the disclosure.

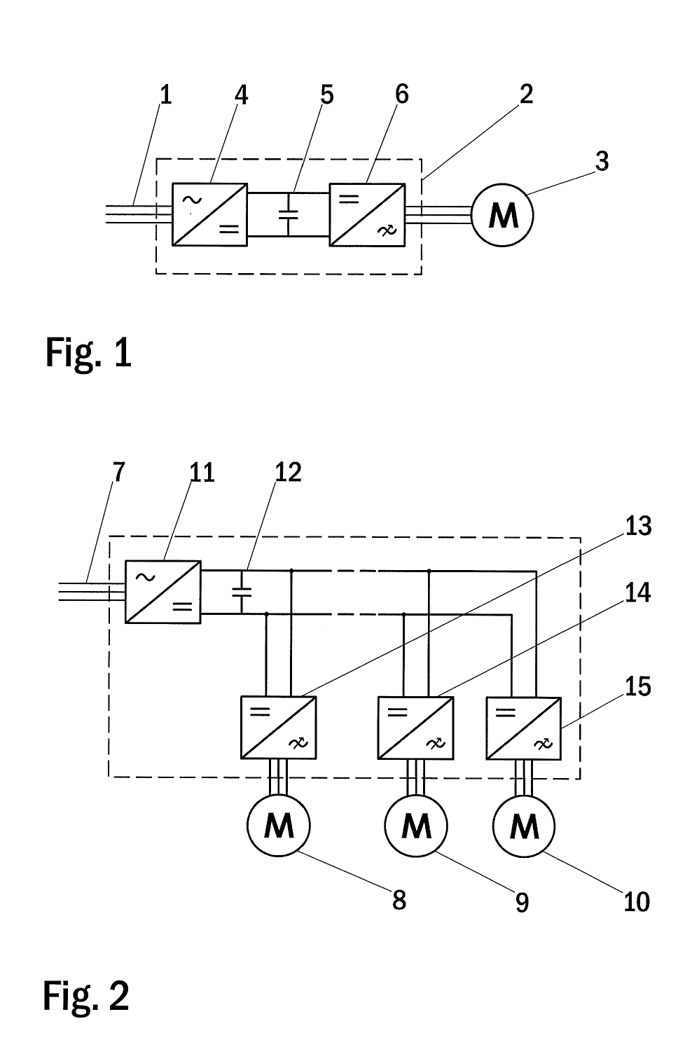

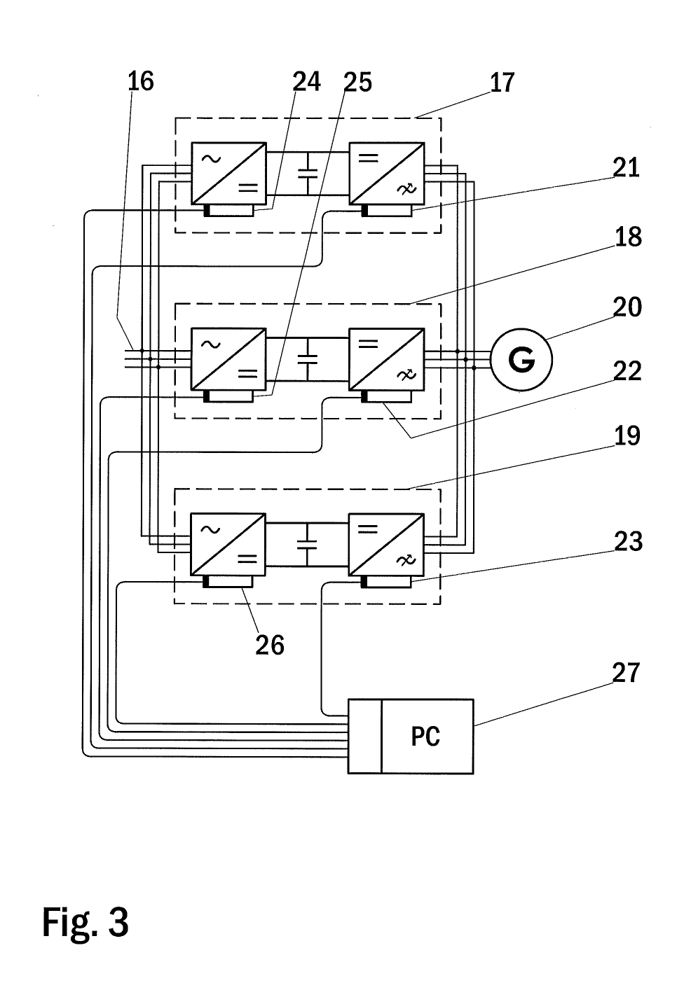

### DETAILED DESCRIPTION

An object of the disclosure is to provide a novel fault diagnostics arrangement for an electric drive system and an electric drive system for different industrial applications.

In a fault diagnostics arrangement of the disclosure for an electric drive system comprises (e.g., consists of) a plural number of electric drive subsystems. The fault diagnostics arrangement of the electric drive system comprises subsystem control boards, to which event data of the subsystems is stored. One of the control boards of the electric drive system serves as a main control board of the electric drive system and the event data of the subsystems are transferred to the main control board from the control boards of the subsystems by a data transfer medium.

An exemplary electric drive system of the present disclosure comprises (e.g., consists of) a plural number of electric drive subsystems and the fault diagnostics arrangement of the electric drive system comprises subsystem control boards, to which event data of the subsystems is stored. One of the control boards of the electric drive system serves as a main control board of the electric drive system and the event data of the subsystems are transferred to the main control board from the control boards of the subsystems by a data transfer medium.

An exemplary fault diagnostics arrangement for an electric drive system and an exemplary electric drive system for different industrial applications has now been developed. The solution is characterized by what is stated in the independent claims. Some of the exemplary embodiments of the disclosure are disclosed in the dependent claims.

The exemplary embodiments of the present disclosure enables a number of advantages to be realized. For example, the exemplary fault diagnostics arrangements of the disclosure for an electric drive can allow a good and reliable picture of a fault situation to be obtained on the main system level of the electric drive. In addition, the exemplary fault diagnostics arrangements of the present disclosure can facilitate the analysis of the fault logger data in a fault examination situation.

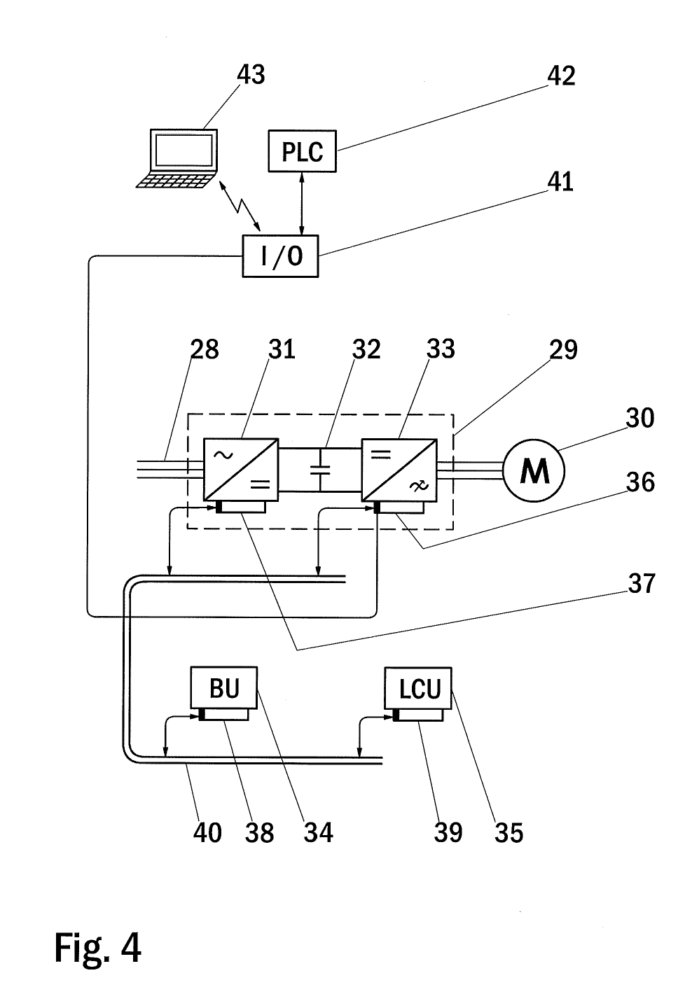

FIG. 4 illustrates an electric drive having a fault diagnostics arrangement in an exemplary embodiment of the present disclosure. The electric drive of the disclosure comprises a power supply 28, a frequency converter 29 and a load 30. The load 30 can be a motor 30, for example. The frequency converter 29 can comprise (e.g., consist of) a rectifier unit 31, a direct voltage intermediate circuit 32, and an inverter unit 33. The rectifier unit 31 of the frequency converter 29 of the electric drive of the disclosure can convert alternating current voltage coming from the power supply 28 to direct current voltage. The frequency converter 29 can be rectified by a 6-pulse diode bridge, for example. The direct voltage obtained from the rectifier unit 31 of the frequency converter 29 is stored to a direct voltage intermediate circuit 32 serving as an energy storage. The direct voltage intermediate circuit 32 of the frequency converter 29 can be implemented using a storage capacitor. From the direct current of the direct current voltage intermediate circuit 32 the inverter unit 33 of the frequency converter 29 produces alternating current of a desired frequency as specified by the motor 30 representing the load. The inverter unit 33 of the frequency converter 29 of the disclosure can be implemented by through an IGBT (Insulated-gate Bipolar Transistor). The electric drive of the disclosure further comprises a brake chopper subsystem 34 and a liquid cooling plant subsystem 35.

A fault diagnostics arrangement of the disclosure for an electric drive the inverter unit 33 comprises a separate control board 36 and a fault logger residing on the control board 36. The arrangement includes a the rectifier unit 31, which comprises a separate control board 37 and a rectifier-unit-specific fault logger residing on the control board 37. The inverter unit 33 and the rectifier unit 31 are subsystems of the electric drive 29. Likewise, the brake chopper subsystem 34 and the liquid cooling plant subsystem 35 comprise separate control boards 38, 39 and unit-specific fault loggers residing on the control boards 38, 39. In addition to the subsystems described in this example, the electric drive of the disclosure can comprise diverse other subsystems, some of which are not involved in the motor control. Each of these subsystems can also have a separate subsystem-specific control board and a separate fault logger data file of the control board.

The electric drive fault diagnostics arrangement of the disclosure also comprises a data transfer medium 40 between the control boards 36 to 39. The data transfer medium 40 between the control boards 36 to 39 can comprise (e.g., consist of) a plural number of separate couplings between the control boards 36 to 39, or the data transfer medium 40 can be a communication bus 40, such as a serial communication bus 40 or an Ethernet-based communication bus 40.

In the electric drive fault diagnostics arrangement of the present disclosure one of the control boards of the electric drive system, for example the control board 36 of the inverter unit 33 serves as the main control board 36 of the electric drive system. In the solution of the disclosure, the data transfer medium 40 transfers the faults of the subsystems 31, 34, 35 from the subsystem-specific control boards 37 to 39 to the main control board 36 of the electric drive system. Consequently, in the solution of the disclosure the fault logger on the main control board 36 of the electric drive system is updated also with the event data of the subsystems 31, 34, 35. The control board 36 of the inverter unit 33 serving as the main control board thus comprises an electric-drive-specific fault logger data file that comprises (e.g., contains) the electric-drive-system-specific event data in a chronological order. Alternatively, the control board 36 of the inverter unit 33 serving as the main control board comprises not only the electric-drive-system-specific fault logger data file but also an inverter-unit-specific fault logger data file.

The electric drive fault diagnostics arrangement of the disclosure further comprises a connection means 41 for enabling a field bus connection to the electric drive system for the control board 36 of the inverter unit 33 which serves as the main control board. The connection means 41 can be configured to enable a connection to a programmable logic controller 42 (PLC). The connection means 41 can also be configured to enable a connection to a computer 43. The connection to the computer 43 enabled by the connection means 41 can be a direct connection or, alternatively, a connection implemented over a telecommunications network, such as an Internet connection.

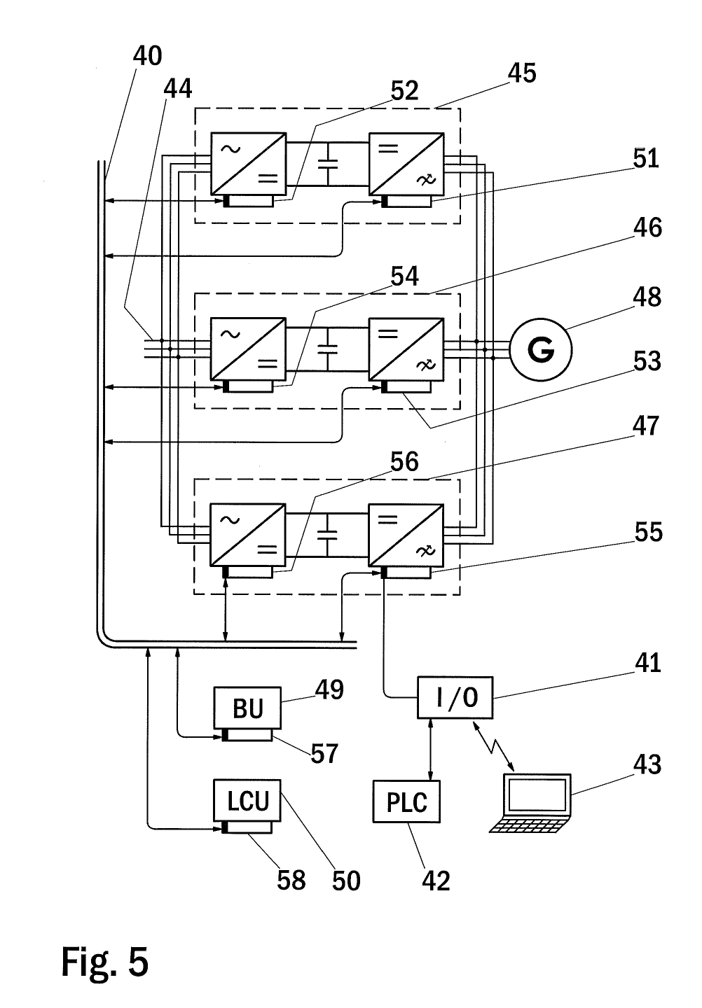

FIG. 5 illustrates an electric drive having a fault diagnostics arrangement for an electric drive of an alternative exemplary embodiment of the present disclosure. The electric drive of the present disclosure can comprise three frequency converter units 45, 46, 47 and a generator 48. When the generator 48 is running, the frequency converter units 45, 46, 47 can convert the electricity produced by the generator 48 to correspond to the frequency of the mains, and supply the electricity thus generated to a network 44. Each of the frequency converter units 45, 46, 47 of the electric drive of the present disclosure can comprise a rectifier unit, a direct voltage intermediate circuit and an inverter unit. Each inverter unit can comprise a separate control board 51, 53, 55. Each rectifier unit can also comprise a separate control board 52, 54, 56. The inverter units and rectifier units of the frequency converter units 45, 46, 47 of the electric drive of the present disclosure are subsystems of the electric drive not separately numbered in the figure.

The exemplary electric drive of the present disclosure further comprises a brake chopper subsystem 49 and a liquid cooling plant subsystem 50. The brake chopper subsystem 49 can comprise a separate control board 57 and, correspondingly, the liquid cooling plant subsystem 50 can comprise a separate control board 58. Each control board 51 to 58 can comprise a fault logger that documents all faults, warnings and other events. In addition to the subsystems described in this example, the electric drive of the disclosure can comprise diverse other subsystems, some of which are not involved in the motor control. Each of these subsystems can also have a separate subsystem-specific control board and a separate fault logger data file of the control board.

In addition, the electric drive fault diagnostics arrangement of the present disclosure can comprise a data transfer medium 40 between the control boards 51 to 58. The data transfer medium 40 can be a communication bus 40, such as a serial communication bus 40 or an Ethernet-based communication bus 40.

One of the control boards of the electric drive system, for example the control board 55 of a selected inverter unit, can serve as the main control board 55 of the electric drive system. The data transfer medium 40 can transfer the faults of the subsystems from the control boards 51 to 54, 56 to 58 to the main control board 55 of the electric drive system, the fault logger on the main control board 55 can be updated with the event data of the subsystems. The electric drive fault diagnostics arrangement of the present disclosure also comprises a connection means 41 for enabling a field bus connection to the electric drive system for the control board 55 of the inverter unit serving as the main control board. The connection means 41 can enable a field bus connection to the programmable logic controller 42 and/or a connection to the computer 43 either directly or over a telecommunications network, such as an Internet connection.

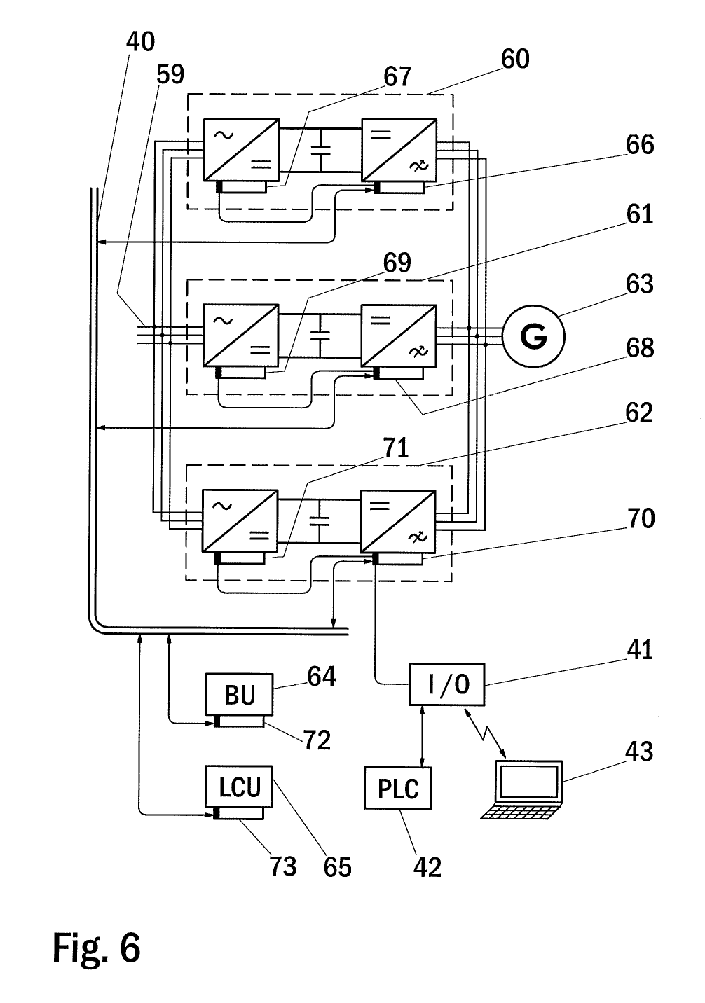

FIG. 6 illustrates an electric drive having a fault diagnostics arrangement in accordance with a second alternative embodiment of the present disclosure. The electric drive of the disclosure comprises three frequency converter units 60, 61, 62 and a generator 63. When the generator 63 is running, the frequency converter units 60, 61, 62 convert the electricity produced by the generator 63 to correspond to the frequency of the mains and supply the electricity thus generated to the network 59. Each of the frequency converter units 60, 61, 62 of the electric drive of the disclosure comprises a rectifier unit, a direct voltage intermediate circuit and an inverter unit. Each inverter unit can comprise a separate control board 66, 68, 70. Each rectifier unit can also comprise a separate control board 67, 69, 71. The inverter units and rectifier units of the frequency converters 60, 61, 62 of the electric drive of the present disclosure are subsystems of the electric drive not separately numbered in the figure.

In an exemplary embodiment the electric drive of the present disclosure further comprises a brake chopper subsystem 64 and a liquid cooling plant subsystem 65. The brake chopper subsystem 64 can comprise a separate control board 72 and, correspondingly, the liquid cooling plant subsystem 65 can comprise a separate control board 73. Each control board 66 to 73 comprises a fault logger that documents all faults, warnings, and other events. In addition to the subsystems described in this example, the electric drive of the disclosure may comprise diverse other subsystems, some of which are not involved in the motor control. Each of these subsystems can also have a separate subsystem-specific control board and a separate fault logger data file of the control board.

In addition, the electric drive fault diagnostics arrangement of the disclosure comprises a data transfer medium 40 between the control boards 66 to 73. The data transfer medium 40 can be a communication bus 40, such as a serial communication bus 40 or an Ethernet-based communication bus 40.

In the electric drive fault diagnostics system according to the second alternative embodiment of the present disclosure one of the control boards of the frequency converter units 60, 61, 62, for example the control boards 66, 68, 70 of the inverter units, serve as frequency-converter-specific control boards 66, 68, 70. Likewise, one of the control boards of the electric drive system, such as the control board 70 of a selected inverter unit, for example, serves as the main control board 70 of the electric drive system.

In the electric drive fault diagnostics arrangement according to the second alternative exemplary embodiment of the disclosure faults detected in subsystems of the frequency converter units 60, 61, 62 can be transferred from the subsystem-specific control boards, such as the control boards 67, 69, 71 of the rectifier units, to the frequency-converter-unit-specific control boards 66, 68, 70, the fault loggers on the frequency-converter-unit-specific control boards 66, 68, 70 being thus updated also with the event data of the subsystems. Likewise, the transfer medium 40 can transfer the frequency-converter-unit-specific fault logger data and the fault data of other subsystems from the frequency-converter-unit-specific control boards 66, 68 of the subsystem level and from the subsystem-specific control boards 72 to 73 to the main control board 70 of the electric drive system, the fault logger on the main control board 70 can be updated also with the event data of the subsystems. The electric drive fault diagnostics arrangement of the disclosure can also comprise a connection means 41 enabling a field bus connection to the electric drive system for the control board 70 of the inverter unit serving as the main control board. The connection means 41 can enable a field bus connection to the programmable logic controller 42 and/or a connection to the computer 43 either directly or over a telecommunications network, such as an Internet connection.

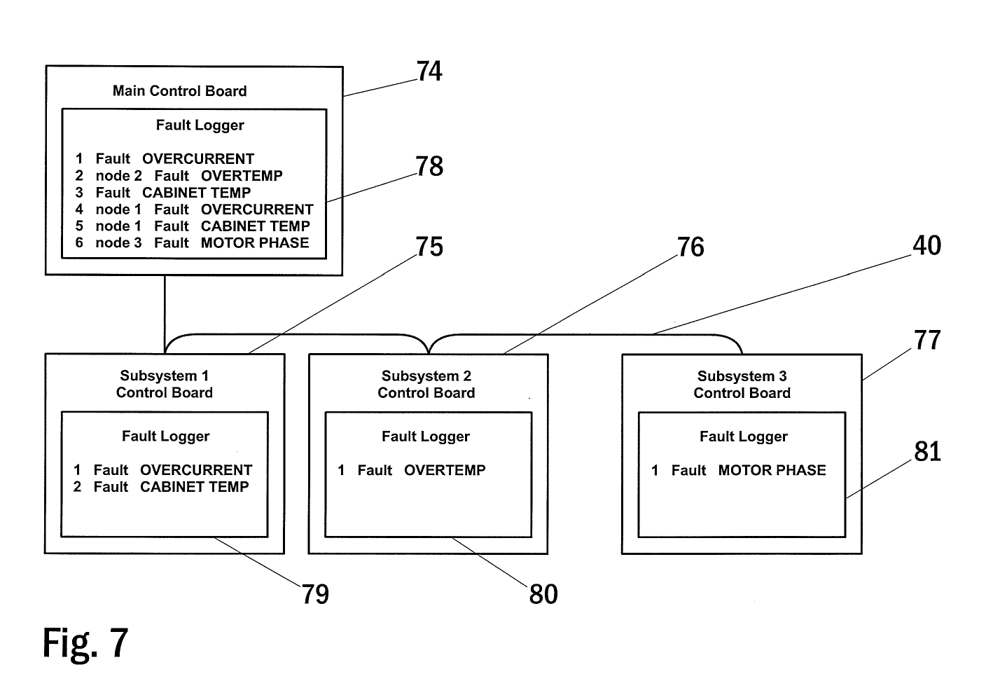

FIG. 7 illustrates an electric drive for the recording of faults in a fault diagnostics arrangement in accordance with an exemplary embodiment of the present disclosure. In fault data can be recorded to fault loggers residing on the control boards. As shown in FIG. 7, the main control board is designated by reference numeral 74, the control boards of the subsystems being designated by reference numerals 75 to 77, respectively. Further, in the figure the fault logger of the main control board 74 is designated by reference numeral 78, the fault loggers of the control boards 75 to 77 of the subsystems being designated by reference numerals 79 to 81, respectively. The data transfer medium between the control boards 74 to 77 is designated by reference numeral 40. The data transfer medium 40 between the control boards 74 to 77 can comprise (e.g., consist of) a plural number of separate couplings between the control boards 74 to 77, or the data transfer medium 40 may be a communication bus 40, such as a serial communication bus 40 or an Ethernet-based communication bus 40.

When faults appear in an electric drive according to an embodiment of the disclosure, the faults are recorded to the fault loggers 79 to 81 of the subsystem control boards 75 to 77 for example as follows:

### Control Board Fault Logger of Subsystem 1

### 1 Fault OVERCURRENT

### 2 Fault CABINET TEMP

### Control Board Fault Logger of Subsystem 2

### 1 Fault OVERTEMP

### Control Board Fault Logger of Subsystem 3

### 1 Fault MOTOR PHASE

In the exemplary embodiment, when faults appear in an electric drive, main system faults can be recorded to the fault logger 78 of the main system control board 74. In addition, the faults recorded to the fault loggers 79 to 81 of the subsystem control boards 75 to 77 can be transferred by the data transfer medium 40 to the fault logger 78 of the main system control board 74. The electric drive fault diagnostics arrangement of the present disclosure can allow all system faults to be presented in a chronological order in the fault logger 78 of the control board 74 for example as follows:

### Fault Logger of the Main Control Board

### 1 Fault OVERCURRENT

### 2 Subsystem 2 Fault OVERTEMP

### 3 Fault CABINET TEMP

### 4 Subsystem 1 Fault OVERCURRENT

### 5 Subsystem 1 Fault CABINET TEMP

### 6 Subsystem 3 Fault MOTOR PHASE

In an exemplary embodiment of the present disclosure, the fault diagnostics messages of the subsystems can be transferred to the main control board 74 as an automated system operation. The system can also be less difficult to maintain. Moreover, the fault diagnostics messages can comprise (e.g., contain) a time stamp of the event, i.e. of the moment when a fault was detected in a subsystem. Based on the exemplary embodiment of the present disclosure, a new fault added to a subsystem, for example, does not generate a software change to the main control board. Fault texts relating to each fault, including the fault code to be transferred to the field bus, are also transferred from the subsystems to the software of the main control board 74. The fault code can allow the program application residing on the programmable logic controller 42 and/or the computer 43 to identify the fault type.

In the electric drive fault diagnostics arrangement of the disclosure the subsystems 31, 34, 35, 49, 50, 64, 65 can be connected together by the data transfer medium 40 comprising (e.g., consisting of) a common communication bus or separate buses. Upon request, the control boards 37 to 39, 51 to 54, 56 to 58, 67, 69, 71 to 73, 75 to 77 of the subsystems 31, 34, 35, 49, 50, 64, 65 can transmit their status data rapidly to the main control board 36, 55, 70, 74 to which the connection medium 41 enabling the field bus connection is coupled. In the electric drive fault diagnostics arrangement of the disclosure, fault texts relating to each fault, including the fault code to be transferred to the field bus by the connection medium 41, can also be transferred from the control boards 37 to 39 of the subsystems 31, 34, 35, 49, 50, 64, 65 to the software of the main control board 36, 55, 70, 74. The fault code can allow the program application residing on the programmable logic controller 42 to identify the fault type.

Because the statuses of the subsystems 31, 34, 35, 49, 50, 64, 65 are updated rapidly, process blocks can be implemented without delay. A fault triggered in a subsystem 31, 34, 35, 49, 50, 64, 65 critical from the process point of view can be interlocked with the shutdown of the entire system in the software of the main control board 36, 55, 70, 74 or the programmable logic controller 42. When a less critical fault appears, the process control can continue under the control specified by the system.

The electric drive fault diagnostics arrangement of the present disclosure can allow improved electric drive diagnostics by transferring on the system level, subsystem faults over a serial communication link or a similar data transfer method to the main control board of the system. This enables a clearly improved total management of an electric drive system.

The exemplary embodiments described in the present disclosure can provide a novel fault diagnostics arrangement for use in an electric drive system for different industrial electric drive applications. This fault diagnostics arrangement can allow a sufficiently reliable picture of a fault situation to be conveyed on the main system level of the electric drive and to significantly facilitate analysis of fault logger data in a fault examination situation, for example.

The exemplary electric drive fault diagnostics arrangements provided in the present disclosure can be applied in the energy industry in electric drives of turbines of wind power industry or in solar power industry, for example. The electric drive fault diagnostics arrangement of the disclosure can be applicable to transport vehicle engines in shipping, for example, to be used in electric drives of ship engines, and to different process and manufacturing technological equipment.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the fore-going description and all changes that come within the meaning and range and equivalence thereof are intended to be embraced therein.

What is claimed is:

1. A fault diagnostics arrangement for an electric drive system having a plurality of electric subsystems, comprising:
control boards having, event data of the subsystems recorded thereon,
wherein one of the control boards of the electric drive system is a main control board to which event data of each subsystem is transferred from a respective control board by a data transfer medium.

2. The fault diagnostics arrangement according to claim 1, wherein each electric drive subsystem comprises at least one of:
a rectifier unit,
an inverter unit,
a brake chopper subsystem, and
a liquid cooling plant subsystem.

3. The fault diagnostics arrangement according to claim 1, wherein the electric drive system further comprises:
frequency converter units,
wherein one or more of the control boards of the electric drive serves as frequency-converter-unit-specific control boards to which the event data of the subsystems of the frequency converter unit are transferred from the respective control boards of each subsystem, and
wherein the frequency-converter-unit-specific control boards transfer the frequency-converter-unit-specific event data to the main control board of the electric drive system by the data transfer medium.

4. The fault diagnostics arrangement according to claim 1, wherein the data transfer medium comprises a plural number of separate couplings between each control board, or the transfer medium is a communication bus, a serial communication bus or an Ethernet-based communication bus.

5. The fault diagnostics arrangement according to claim 1, further comprising:
connection means for enabling a field bus connection to the electric drive system for the main control board.

6. The fault diagnostics arrangement according to claim 5, wherein the connection means enables a field bus connection to a programmable logic controller, and/or a connection to a computer.

7. The fault diagnostics arrangement according to claim 6, wherein the connection to the computer enabled by the connection means is a direct connection, a connection implemented over a telecommunications network, or a connection implemented over an Internet connection.

8. The fault diagnostics arrangement according to claim 1, wherein the event data is recorded to fault loggers of the control boards.

9. The fault diagnostics arrangement according to claim 1, wherein the event data comprises a time stamp of a moment when a fault was detected.

10. The fault diagnostics arrangement according to of claim 1, wherein the event data compries a fault code that enables a programmable logic controller and/or a computer to identify a fault type.

11. The fault diagnostics arrangement according to claim 1, wherein based on the event data, a programmable logic controller and/or a computer shuts down the electric drive system or provides the electric drive system with a specified control.

12. The fault diagnostics arrangement according to claim 1, wherein the arrangement is applied to electric drives of turbines in a wind power industry.

13. The fault diagnostics arrangement according to claim 1, wherein the arrangement is applied to electric drives of solar power industry.

14. The fault diagnostics arrangement according to claim 1, wherein the arrangement is applied to electric drives of ship engines.

15. An electric drive system comprising:
a plural number of electric drive subsystems having a fault diagnostics arrangement,
wherein the arrangement comprises a respective control board for each subsystem,
wherein event data of each subsystem is recorded on the respective control board, and
wherein one of the respective control boards of the electric drive system is a main control board to which the event data of a subsystem is transferred from the respective control board by a data transfer medium.
